(19) United States
(12) Patent Application Publication
(10) Pub. No.: US 2006/0286234 A1
(43) Pub. Date: Dec. 21, 2006

(54) Dehydrating and sterilizing system for processing food products and method therefor

(75) Inventors: Hsun-Heng Tsai, Tainan City (TW); Chih-Chieh Chung, Hsinchu City (TW); Chih-Hao Chung, Hsinchu City (TW)

Correspondence Address: NIKOLAI & MERSEREAU, P.A., 900 SECOND AVENUE SOUTH, SUITE 820, MINNEAPOLIS, MN, 55402, US

(73) Assignee: Hsun-Heng Tsai, Tainan City (TW)

(21) Appl. No.: 11/443,320

(22) Filed: May 30, 2006

(30) Foreign Application Priority Data
Jun. 2, 2005 (TW) 094118247

(51) Int. Cl. A23L 3/16

(52) U.S. Cl. 426/521

(57) ABSTRACT

A dehydrating and sterilizing system includes an operating chamber, a vacuum pump unit, a microwave source and a plasma source. The operating chamber is used to contain food products, and is connected with the vacuum pump unit that can discharge air from the operating chamber for vacuum-dehydrating operation. The microwave source communicates with the operating chamber for a microwave processing procedure. The plasma source further communicates with the operating chamber for a plasma processing procedure. The method includes the steps of: pretreating operation; vacuuming operation; microwave-dehydrating operation; and plasma-sterilizing operation.

### BACKGROUND OF THE INVENTION

1. Field of the Invention

The present invention relates to a dehydrating and sterilizing system and method thereof for processing food products. More particularly, the present invention relates to the dehydrating and sterilizing system and method thereof employing microwaves and plasmas in a vacuum for processing food products or the likes.

2. Description of the Related Art

Generally, conventional processing methods for food products such as agricultural products, livestock products, seafood products or the likes include a heat-dehydrating method, a vacuum-dehydrating method and a microwave-dehydrating method. However, these methods for processing food products have several technical drawbacks as discussed in more greater detail below.

Firstly, the heat-dehydrating method must supply heat air for a long period of processing time so as to continuously dry food products in a food-processing procedure. However, in longer heat-dehydrating operation, heats may cause significant changes in appearances of food products such as colors or structural completeness that are undesirable. In addition to this, heats may destroy the organizations of foods such as damage to valuable contained-nutrients. Another problem with the heat-dehydrating method is a need of cooling operation at the end of the procedure. In brief, the conventional heat-dehydrating method may cause a certain extent of change in appearances, and damage to contained-nutrients of foods in addition to a need for a longer processing time.

The vacuum-dehydrating method must also be proceeding for a long period of predetermined vaporizing time so as to continuously evaporate water contents of foods in a food-processing procedure. In other words, water contents of foods must be evaporated in a vacuum environment. Although this method is successful in avoiding change in appearances and damage to contained-nutrients of foods, it would be disadvantageous to proceed a long-term vaporizing time. However, the conventional vacuum-dehydrating method may still require a longer processing time.

The microwave-dehydrating method must also be proceeding for a long period of predetermined vaporizing time so as to continuously evaporate water contents of foods in a food-processing procedure. Similarly, heats resulted from microwave may also cause significant changes in appearances of food products such as colors or structural completeness or damage to contained-nutrients of foods. More similarly, there is also a need of cooling operation at the end of the food-processing procedure. In brief, the conventional microwave-dehydrating method may still cause a certain extent of change in appearances, and damage to contained-nutrients of foods in addition to a need for a longer processing time.

In fact, once food products have been processed in high temperature for either of a short-term or long-term processing time, all contained-nutrients of the foods are completely destroyed at the same time. In any case, food products must therefore avoid being situated in a high-temperature process. Furthermore, a longer processing time for dehydrating food products fails to meet requirements of the highly competitive market. Hence, there is a need for reducing a processing time for dehydrating food products.

Theoretically, food products depending on various types of materials can absorb or reflect microwaves or can be penetrated by microwaves. In conducting microwaves, the interiors of dielectrics existing in foods can generate electric fields while transmitting microwaves therein. Loss or exhaustion of energy of the electric fields may result in exothermic reactions as well as transformation of microwaves into thermal energy. The technical problems with the heat-dehydrating method may be overcome if better and appropriate control of microwave is performed. Functionally, microwave is capable of penetrating through some specific materials. Energy of microwave can cause molecules of water contained in foods to vibrate so that the molecules of water may be heated and evaporated. In microwave-dehydrating operation, it is generally desirable that the whole water content contained in both of surface and internal layers can be released from surfaces of foods at the same time. Conversely, in an ordinarily dehydrating manner, heats must firstly evaporate water content of the surface layer rather than that contained in the internal layers. Frankly, the ordinary heat-dehydrating method cannot dehydrate the surface and internal layers at the same time.

In addition, there is a need for a sterilizing procedure such as high-temperature sterilization for food products since viruses and germs may exist in the room temperature. As noted above, once the food products are processed in high temperature, heats can completely destroy all contained-nutrients of the foods. Meanwhile, heats can cause significant changes in appearances of food products such as colors or structural completeness that are undesirable. In any case, food products must therefore avoid being situated in a high-temperature process. Furthermore, an additional cooling procedure for the heated food products can be burdensome to the manufacturer.

It is known that plasmas can carry out sterilization for food products in low or room temperature due to the fact that charged particles of plasmas can cause significant destruction to cell membranes of viruses or germs within a second or in short-term operation. Therefore, plasmas for use in sterilization in low or room temperature have been found to be suitable. In low-temperature sterilization, suitably controlling an amount of plasmas can be applied to food products.

As is described in greater detail below, the present invention intends to provide a dehydrating and sterilizing method for processing food products. Microwaves and plasmas are employed to process food products in dehydrating and sterilizing operation so as to avoid a high-temperature environment and a long-term processing time in such a way as to mitigate and overcome the above problem.

### SUMMARY OF THE INVENTION

The primary objective of this invention is to provide a dehydrating system and method thereof for processing food products, wherein microwaves are employed to evaporate water contents of foods in a predetermined degree of vacuum. Accordingly, the dehydrating system and method thereof can enhance the efficiency of dehydrating operation for food products.

The secondary objective of this invention is to provide a dehydrating and sterilizing system and method thereof for processing food products, wherein both of microwaves and plasmas are applied to the food products. Accordingly, the dehydrating and sterilizing system and method thereof can carry out dehydration and sterilization for food products.

The dehydrating and sterilizing system in accordance with an aspect of the present invention includes an operating chamber, a vacuum pump unit, a microwave source and a plasma source. The operating chamber is used to contain food products, and is connected with the vacuum pump unit that can discharge air from the operating chamber for vacuum-dehydrating operation. The microwave source communicates with the operating chamber for a microwave processing procedure. The plasma source further communicates with the operating chamber for a plasma processing procedure.

The dehydrating and sterilizing method in accordance with a separate aspect of the present invention includes the steps of: providing a low-pressure environment for a food product so as to lower an evaporating point of the water contents contained in the food; processing the food product with microwaves in the low-pressure environment such that energies of the microwaves is capable of evaporating the water contents contained in the food; and processing the food product with plasmas in room temperature for sterilization.

In a further separate aspect of the present invention, the operating chamber is selected from a dehydrating/sterilizing vessel, including a turntable and a motor device connected thereto.

In a yet further separate aspect of the present invention, the vacuum pump unit includes an air-discharging valve to connect the operating chamber.

In a yet further separate aspect of the present invention, the microwave source is constructed from a microwave generator, including a microwave-shielding mesh to connect with the operating chamber.

In a yet further separate aspect of the present invention, the plasma source is constructed from an active gas generator, including an active gas valve member to connect with the operating chamber.

In a yet further separate aspect of the present invention, an active gas is used to produce a plasma gas of the plasma source, wherein the active gas is selected from one of argon, oxygen or other equivalent active gases.

In a yet further separate aspect of the present invention, the method further includes the step of pretreating operation for the food products.

In a yet further separate aspect of the present invention, the low-pressure environment is preferably maintained at a predetermined pressure in the range of 10 torr to 300 torr.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram illustrating a dehydrating and sterilizing system and method thereof for processing food products in accordance with a preferred embodiment of the present invention;

FIG. 2 is a schematic diagram illustrating a dehydrating and sterilizing apparatus for processing food products in accordance with the preferred embodiment of the present invention in FIG. 1; and

FIG. 3 is a flow chart illustrating the dehydrating and sterilizing method for processing food products in accordance with the preferred embodiment of the present invention.

### DETAILED DESCRIPTION OF THE INVENTION

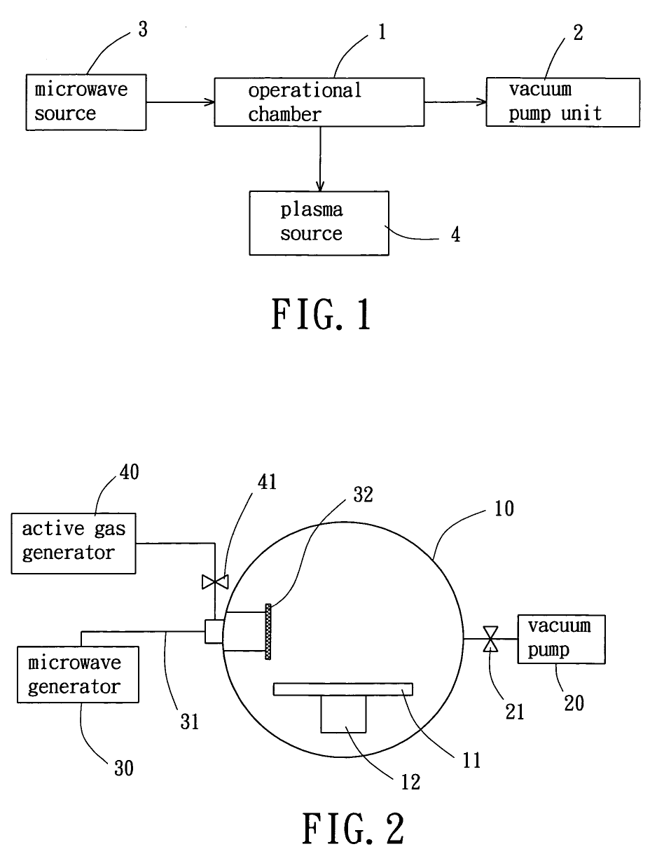

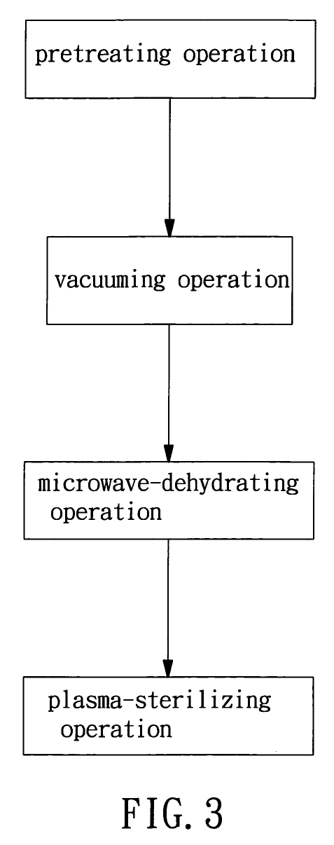

Referring now to FIG. 1, a block diagram of a dehydrating and sterilizing system and method thereof in accordance with the preferred embodiment of the present invention is illustrated, wherein the dehydrating and sterilizing system includes four separate units. Referring further to FIG. 2, a schematic diagram of a dehydrating and sterilizing apparatus in accordance with the preferred embodiment of the present invention is illustrated. Referring further to FIG. 3, a flow chart of the dehydrating and sterilizing method in accordance with the preferred embodiment of the present invention is illustrated, wherein the dehydrating and sterilizing method includes four successive blocks of steps.

Referring again to FIG. 1, the dehydrating and sterilizing system includes an operating chamber designated numeral 1, a vacuum pump unit designated numeral 2, a microwave source designated numeral 3 and a plasma source designated numeral 4. The operating chamber 1 preferably is an airtight chamber which is used to contain food products or other equivalent materials. In this illustrated embodiment, the food products such as agricultural products, livestock products or seafood products are only exemplified for a simplified expression without departing from the scope and spirit of the present invention. More preferably, the operating chamber 1 is constructed from a material suitable for microwave and plasma operation.

Still referring to FIG. 1, the operating chamber 1 is connected with a valve member (not shown) of the vacuum pump unit 2 that can discharge air from the operating chamber 1 for vacuum-dehydrating operation such that the food products can be situated in a low-pressure environment. Preferably, an interior of the operating chamber 1 has a decrease of pressure which is maintained in the range of 300 torr to 10 torr. The vacuum pump unit 2 can adjust the inner pressure of the operating chamber 1 as lower as desired via the valve member. Once the food products lie in the low-pressure environment, an evaporating point of water contents contained in the foods is significantly lowered. For example, the evaporating point of the water contents is lowered to a predetermined temperature in the range of 5 degrees to 12 degrees centigrade for easily converting the whole water contents into vapor in lower or room temperature.

In addition, even though dehydration of the food products may proceed and only continue for a shortened period of low-temperature processing time, the low-temperature environment can usually carry out a certain extent of inhibition of growth of germs. However, the low-temperature operation accomplishes the purpose not only of protection for appearances and organizations of the food product but also of control of the growth of germs which are undesirable.

Still referring to FIG. 1, the microwave source 3 is constructed from a microwave-supplying device which communicates with the operating chamber 1. Preferably, the microwave source 3 connects with the operating chamber 1 via a microwave baffle (not shown) which can control connection of the microwave source 3 with the operating chamber 1 for supplying microwaves. In microwave-dehydrating operation, the microwave source 3 transmits microwaves into the interior of the operating chamber 1. Once the microwaves transmitted from the microwave source 3 are guided into the interior of the operating chamber 1, there is an energy exchange of the microwaves to water contents contained in foods that may cause the water contents converting into vapor. Meanwhile, the microwaves can result in an increase of temperatures of the food products but they are controlled in a relatively low temperature, for example 5 degrees to 12 degrees centigrade. However, heats resulted from the microwaves may not damage the contained-nutrients of the food products.

Still referring to FIG. 1, the plasma source 4 is constructed from a plasma-supplying device which communicates with the operating chamber 1. Suitable gases for generating plasmas are argon, oxygen, or other equivalent active gases. Preferably, the plasma source 4 connects with the operating chamber 1 via a valve member (not shown) which can control connection of the plasma source 4 with the operating chamber 1 for supplying plasmas for use in sterilization. Typically, the plasma source 4 generates plasmas by activating the active gas such as microwave-activated active gas which are converted into plasmas gas. In plasma-sterilizing operation, the plasmas gas supplied from the plasma source 4 can perfectly prevent the food products from contamination. There is a consideration of existing several germs on the food products even though they are situated in low or extremely low temperature. In the operating chamber 1, the plasmas gas supplied from the plasma source 4 causes damage to germs by free radicals of the plasma gas penetrating through membranes of germs such that the free radicals of the plasma gas are capable of destroying the organizations of germs. Accordingly, it would be advantageous to employ plasmas in the plasma-sterilizing operation, thereby carrying out sterilization in low-temperature environment.

The construction of the dehydrating and sterilizing apparatus shall be described in detail, by referring now to FIG. 2. In the preferred embodiment, the dehydrating and sterilizing apparatus includes a dehydrating/sterilizing vessel 10, a vacuum pump 20, a microwave generator 30 and an active gas generator 40. Preferably, the dehydrating/sterilizing vessel 10 includes a turntable 11 and a motor device 12 connected thereto. In the dehydrating/sterilizing vessel 10, the food products are arranged on the turntable 11 which is rotated by the motor device 12.

Still referring to FIG. 2, the vacuum pump 20 is selected from an ordinary pump device and connected with the dehydrating/sterilizing vessel 10 via an air-discharging valve 21. When the vacuum pump 20 starts, the air-discharging valve 21 is opened to discharge air remained in the dehydrating/sterilizing vessel 10. Accordingly, a vacuuming procedure is processed in the dehydrating/sterilizing vessel 10.

Still referring to FIG. 2, the microwave generator 30 is selected from an ordinary microwave device such as a microwave oven, and communicated with the dehydrating/sterilizing vessel 10. In a preferred embodiment, the microwaves are performed by electromagnetic waves having a wavelength in the range of 0.1 cm to 15.0 cm which can be absorbed by the water contents of the food products. Consequently, the energies of the microwaves are capable of exchanging with the water contents contained in the food products. In the preferred embodiment, the microwave generator 30 has a microwave tube 31 and a microwave-shielding mesh 32 to connect with the dehydrating/sterilizing vessel 10 so as to transmit microwaves to the interior of the dehydrating/sterilizing vessel 10. When the microwave generator 30 starts, the microwave-shielding mesh 32 must be opened or removed to transmit microwaves. Accordingly, a microwave-dehydrating procedure is processed in the dehydrating/sterilizing vessel 10.

Still referring to FIG. 2, the active gas generator 40 is selected from an ordinary plasma source such as an active gas tank, and communicated with the dehydrating/sterilizing vessel 10. In a preferred embodiment, the active gas generator 40 can generate a plasma gas by employing one of argon, oxygen, and other equivalent active gases. In general, the plasma gas contains ionized particles of the active gas. For instance, if the oxygen functions as an active gas, ozone may be generated and can be used for sterilization. In the preferred embodiment, the active gas generator 40 has an active gas valve member 41 to communicate with the dehydrating/sterilizing vessel 10 so as to supply the plasma gas to the interior of the dehydrating/sterilizing vessel 10. When the active gas generator 40 starts, the active gas valve member 41 must be turned on to supply the active gas. Preferably, the microwave generator 30 can further transmit microwaves that activate the active gas to form a plasma gas. Accordingly, a plasma-sterilizing procedure is processed in the dehydrating/sterilizing vessel 10.

In activating the active gas, the plasmas may still continuously dehydrate the food products. In order to prevent an excessive microwave-dehydration, the microwave-shielding mesh 32 must be closed to isolate the food products from the microwaves. The active gas supplied from the active gas generator 40 may be limited within a space located between the active gas generator 40 and the microwave-shielding mesh 32 for activating operation. Accordingly, a predetermined amount of the plasma gas is generated. Subsequently, the plasma gas is supplied to the dehydrating/sterilizing vessel 10 via the microwave-shielding mesh 32.

Turning now to FIG. 3, the dehydrating and sterilizing method in accordance with the preferred embodiment of the present invention includes the step of pretreating operation such as classifying or cleaning operation for the food products. The term “pretreating” refers to a process where a food product may be treated prior to the following steps. In an alternative embodiment, the step of pretreating operation for the food products may be omitted or repeated without departing from the scope and spirit of the present invention.

Still referring to FIG. 3, subsequently, the dehydrating and sterilizing method in accordance with the preferred embodiment of the present invention includes the step of vacuuming operation for the food products. In this manner, the water contents contained in the food products are situated in a low-pressure environment such that an evaporating point of the water contents is lower to a predetermined temperature. In the preferred embodiment, the water contents contained in the food products can be evaporated in low or room temperature, thereby converting the water contents into vapor in a relatively lower temperature in the range of 5 degrees to 12 degrees centigrade for example. Referring back to FIG. 2, the vacuum pump 20 and the air-discharging valve 21 are turned on to process the vacuuming operation in the dehydrating/sterilizing vessel 10. Preferably, the interior of the dehydrating/sterilizing vessel 10 may be maintained at a pressure in the range of 10 torr to 300 torr. The vacuum pump 20 and the air-discharging valve 21 may be selectively turned off once the inner pressure of the dehydrating/sterilizing vessel 10 is dropped in the range of 10 torr to 300 torr.

Referring again to FIG. 3, subsequently, the dehydrating and sterilizing method in accordance with the preferred embodiment of the present invention includes the step of microwave-dehydrating operation for the food products. In this manner, the energy of the microwaves can evaporate the water contents of the food products. Referring back to FIG. 2, the microwave generator 30 is turned on and microwave-shielding mesh 32 is opened to process the microwave-dehydrating operation in the dehydrating/sterilizing vessel 10. In order to enhance the effect of the microwave-dehydrating operation, the motor device 12 continuously drives the turntable 11 to turn in the dehydrating/sterilizing vessel 10. The vacuum microwave generator 30 may be turned off and microwave-shielding mesh 32 may be closed so as to avoid any excessively dehydrating operation.

Referring again to FIG. 3, lastly, the dehydrating and sterilizing method in accordance with the preferred embodiment of the present invention includes the step of plasma-sterilizing operation for the food products. In this manner, plasmas can sterilize any possible germs existing in the food products. Referring back to FIG. 2, the active gas generator 40 and the active gas valve member 41 are turned on to process the plasma-sterilizing operation in the dehydrating/sterilizing vessel 10. Preferably, the microwave generator 30 is turned on to generate microwaves that activate the active gas to form a plasma gas. In order to enhance the effect of the plasma-sterilizing operation, the motor device 12 continuously drives the turntable 11 to turn in the dehydrating/sterilizing vessel 10. Preferably, the microwave-dehydrating operation may be terminated prior to processing plasma-sterilizing operation. In a preferred embodiment, both of the microwave-dehydrating operation and the plasma-sterilizing operation may be processed in one-step operation. Consequently, the separate plasma-sterilizing operation may be omitted without departing from the scope and spirit of the present invention.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A dehydrating and sterilizing system for processing food products, comprising:
an operating chamber that contains the food products;
a vacuum pump unit connected with the operating chamber for vacuuming operation;
a microwave source generating microwaves, the microwave source communicated with the operating chamber for microwave-dehydrating operation; and
a plasma source generating plasmas, the plasma source communicated with the operating chamber for plasma-sterilizing operation.

2. The dehydrating and sterilizing system as defined in claim 1, wherein the operating chamber is selected from a dehydrating/sterilizing vessel which includes a turntable and a motor device connected thereto.

3. The dehydrating and sterilizing system as defined in claim 1, wherein the vacuum pump unit includes an air-discharging valve to connect the operating chamber.

4. The dehydrating and sterilizing system as defined in claim 1, wherein the microwave source is constructed from a microwave generator which includes a microwave-shielding mesh to connect with the operating chamber.

5. The dehydrating and sterilizing system as defined in claim 1, wherein the plasma source is constructed from an active gas generator which includes an active gas valve member to connect with the operating chamber.

6. The dehydrating and sterilizing system as defined in claim 1, wherein an active gas is used to produce a plasma gas of the plasma source, the active gas is selected from one of argon, oxygen or other equivalent active gases.

7. A dehydrating and sterilizing method for processing food products, comprising the steps of:.
providing a low-pressure environment for the food products by vacuuming operation;
processing the food products with microwaves in the low-pressure environment for microwave-hydrating operation; and
processing the food products with plasmas for plasma-sterilization operation.

8. The dehydrating and sterilizing method as defined in claim 7, further comprising the step of pretreating operation prior to the vacuuming operation.

9. The dehydrating and sterilizing method as defined in claim 7, wherein the low-pressure environment is maintained at a predetermined pressure in the range of 10 torr to 300 torr.

10. The dehydrating and sterilizing method as defined in claim 7, wherein the microwave-hydrating operation is terminated prior to processing the plasma-sterilizing operation.

11. The dehydrating and sterilizing method as defined in claim 7, wherein an active gas is used to produce a plasma gas, the active gas is selected from one of argon, oxygen or other equivalent active gases.
